(19) United States
(12) Patent Application Publication
(10) Pub. No.: US 2005/0252664 A1
(43) Pub. Date: Nov. 17, 2005

(54) Fire protection sprinkler system

(76) Inventors: Gerald M. Clum, Waverly, PA (US); Eric M. Clum, Olyphant, PA (US)

Correspondence Address: PEPPER HAMILTON LLP, ONE MELLON CENTER, 50TH FLOOR, 500 GRANT STREET, PITTSBURGH, PA, 15219, US

(21) Appl. No.: 10/895,536

(22) Filed: Jul. 21, 2004

Related U.S. Application Data
(60) Provisional application No. 60/569,954, filed on May 11, 2004.

(51) Int. Cl. A62C 35/00

(52) U.S. Cl. 169/17

(57) ABSTRACT

A method and system for creating a vacuum in a dry sprinkler system to evacuate water when the sprinkler system is inactive and to assist in the quick dispersion of water through the sprinkler system when a fire event occurs are disclosed. A vacuum apparatus establishes a vacuum that is within the design pressure capability of sprinkler drops in the sprinkler system. A pressure regulator monitors the pressure and automatically activates the vacuum apparatus when a vacuum loss is detected. A valve is activated when a fire event occurs so that water is drawn through the sprinkler system quickly.

### RELATED APPLICATIONS AND CLAIM OF PRIORITY

This application claims priority to and incorporates by reference in its entirety, U.S. Provisional Application No. 60/569,954 entitled “Fire Protection Sprinkler System” and filed May 11, 2004.

### TECHNICAL FIELD

The present invention generally relates to fire protection systems. More particularly, the present invention relates to a fire protection sprinkler system that includes a vacuum to evacuate the system when the sprinkler heads are not activated.

### BACKGROUND

Most commercial buildings, hotels, hospitals and nursing homes are required by law to include fire extinguishing sprinkler systems in the building. In addition, sprinkler systems are increasingly used in residential applications, including apartment buildings, condominiums and homes. The sprinkler systems are generally housed in or near the ceilings of one or more floors of the building and are made of pipes having varying diameters. The systems are fed by a water supply line and are designed to deliver large amounts of water to a fire upon activation. The systems are typically activated when smoke or intense heat is detected.

Sprinkler systems can be classified in two general categories: “wet” systems and “dry” systems. A “wet” system's pipes are permanently filled with water, which is immediately expelled through the sprinkler heads when the system is activated. Although wet systems have the benefit of immediate delivery of water upon activation, they are not suitable for installations where any part of the system is at risk for damage caused by freezing water. In addition, wet systems can create water damage if a sprinkler head malfunctions or is opened accidentally.

“Dry” systems are available for installations where a risk of freezing exists or where avoidance of water flow or leakage is critical. In current dry systems, the system's pipes are generally empty of water. Air pressure is used in such systems to force air out of the pipes. When the air pressure is relieved, water flows into the pipes and is delivered to the heads. The resistance created by the water forcing the air out adds to the time that it takes for the water to reach the sprinkler heads.

Current dry systems contain several disadvantages. First, since water must be delivered to all points in the system in a very short period of time upon activation, several standards have been set that restrict the design of the system. For example, the National Fire Protection Association (NFPA) requires most current dry systems to have an increased design area in order to account for a larger fire that may result from waiting for the water to arrive at the affected area of the system. To ensure that the water reaches all points in a system quickly, the NFPA also restricts most dry systems to a 750-gallon capacity. Moreover, the NFPA prohibits such systems from using a grid design layout unless the designer can demonstrate that the water will arrive at the portion of the system that is most remote from the source within 60 seconds. Thus, a system that allows for reduced pipe sizes, as well as grid/loop designs that can allow for quick water delivery to the sprinkler heads, is desirable. Second, since compressed air is almost always present in the system, moisture that is naturally present in the air can condense on the outside of the system and corrode the inside of the system, especially in cold temperature environments.

A few prior art systems have attempted to overcome these problems by applying a vacuum to the system. However, these systems also contain several disadvantages. For example, U.S. Pat. No. 5,927,406, to Kadoche, describes a sprinkler system to which a vacuum is applied. The system activates and delivers water to the system whenever the system is returned to atmospheric pressure. However, the system in Kadoche requires specially designed sprinkler heads. Moreover, the system contains no means of distinguishing between a pressure change that is due to a fire and a pressure change that results from a sprinkler head malfunction.

U.S. Pat. No. 6,715,561, to Franson, describes another vacuum system that requires specially designed sprinkler heads. The requirement of specially designed heads creates a significant financial deterrent to the use of the existing vacuum systems. Moreover, the system poses a significant risk of water damage to a building and its contents if any sprinkler head malfunctions or is damaged.

Consequently, a need exists for a vacuum dry sprinkler system that can be used in existing sprinkler installations without requiring substantial redesign of the system or the use of specially designed sprinkler heads.

A need also exists for a method of delivering water through an existing sprinkler system without requiring substantial redesign of the system, as well as through new systems in a manner that allows for reduced pipe sizes, and for grid and loop systems.

This invention is directed to solving one or more of the above-described problems.

### SUMMARY

Before the present methods and systems are described, it is to be understood that this invention is not limited to the particular methodologies and systems described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “sprinkler head” is a reference to one or more sprinkler heads and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a dry sprinkler system includes a network of pipes and sprinkler drops, a first water source, a vacuum apparatus that maintains a regulated vacuum on the network under normal operation, and a first valve that is activated upon a detection of a fire event so that activation of the valve causes water to be delivered to the network from the first water source. The regulated vacuum may be a pressure that is within the design capability of the sprinkler system, such as a pressure that is between about two inches and about ten inches of mercury. Optionally, the first valve is a three-way valve having a first port that is connected to the first water source, a second port connected to a second water source, and a third port connected to the network, such that first valve is activated by water from the second water source being removed from the second opening. However, two-port valves, and other multi-port valves, are possible. In an embodiment, a pressure sensor causes the system to prevent the delivery of water from the first source to the network unless a fire event is also detected. In addition, a heat or smoke sensor, such as a solenoid, may cause the system to permit the delivery of water from the first source to the network when a fire event is also detected.

In an alternate embodiment, a system for applying a vacuum to a dry sprinkler system includes a valve having at least three ports, including a first water source port, a second port, and a water delivery port. The valve also includes a seat that prevents water from being delivered from the first water source port to the water delivery port in normal operation. The system also includes a vacuum apparatus that creates a vacuum on a sprinkler piping network when the sprinkler piping network is connected to the water delivery port. The system also includes an actuator that, upon a detection of a fire event, causes the seat to open so that water may be delivered from the first water source port to the water delivery port. Optionally, the system may also include a pressure regulator, and the vacuum apparatus may include a power source and switch. The switch may be activated when the pressure regulator detects a pressure that is above a predetermined level. Optionally, actuator includes a water source and fire detector, wherein the water source is directed away from the second port upon detection of the fire event.

In an alternate embodiment, a method of creating a vacuum in a dry sprinkler system includes the steps of: (i) connecting a vacuum apparatus to a sprinkler system, wherein the apparatus includes a vacuum pump and a power source; (ii) establishing, by the vacuum apparatus, a vacuum in the sprinkler system, wherein the vacuum is within the design pressure capability of sprinkler drops in the sprinkler system; (iii) monitoring, by the pressure regulator, the vacuum; and (iv) automatically increasing, by the vacuum apparatus, the vacuum when the pressure regulator detects a pressure drop in the sprinkler system. The method may also include removing one or more sprinkler heads from their corresponding sprinkler drops in the sprinkler system after the vacuum is established to siphon trapped water from the sprinkler drops.

### BRIEF DESCRIPTION OF THE DRAWINGS

The accompanying drawings, which are incorporated in and form a part of the specification, illustrate various embodiments and, together with the description, serve to explain the principles of the various embodiments.

FIG. 1 is a block diagram illustrating exemplary features of a dry sprinkler system according to an embodiment.

FIG. 2 is an expanded view of several of the features originally illustrated in FIG. 1.

FIG. 3 is an expanded valve that may be used in an embodiment.

FIG. 4 is a side view of an exemplary vacuum application apparatus.

### DETAILED DESCRIPTION

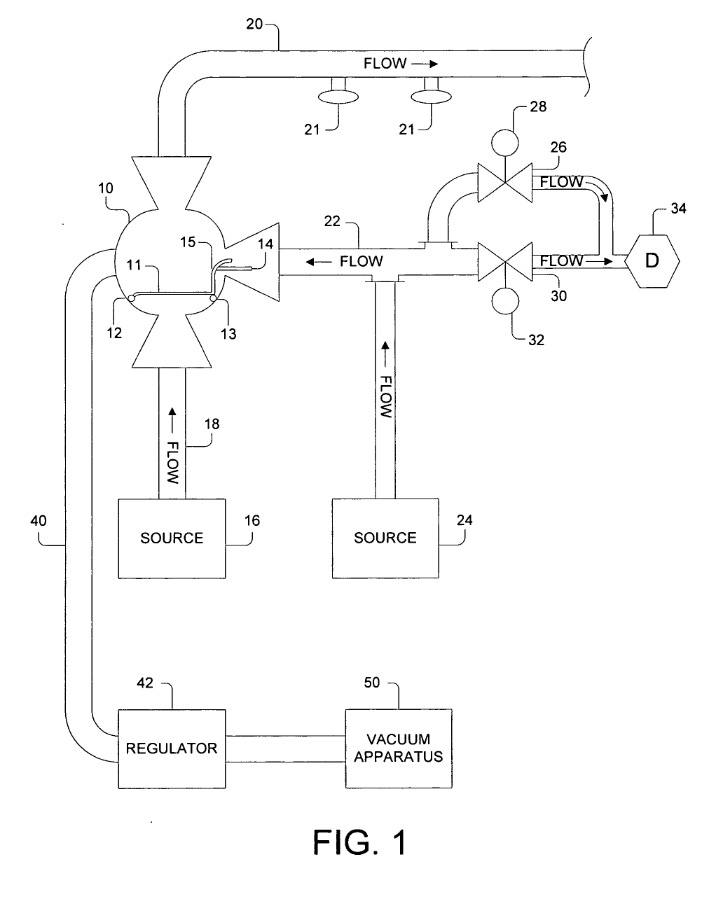

Referring to FIG. 1, an embodiment of a novel dry sprinkler system is illustrated in a block diagram. The exemplary system includes a three-way valve 10 that receives water from a water source 16 via a source pipe 18. The valve controls the delivery of water from the source 16 to a plurality of sprinkler heads 21 via one or more pipes 20. Preferably, each port of the valve 10 is connected by a water-resistant gasket or seal (not shown) to its corresponding piping (i.e., the source 16, piping 22 and/or the sprinkler network 20).

To ensure that the pipes 20 are at least substantially empty when the sprinkler system is inactive, the valve may include a seat 11 that seals off the flow of water from source 16 when water pressure is also present from source 24. The seat 11 may be made of any durable, water-resistant material. In a preferred embodiment, the seat 11 is made of brass with a hard neoprene rubber coating. However, those skilled in the art will recognize that the seat 11 may be made of other materials as well. The seat 11 may be connected to a first hinge 12 around which the seat may swivel when a camber 15 is lifted. The camber 15 may be connected to a second hinge 13. A pin or piston 14 may open the seat 11 and allow delivery of water from source 16 to the sprinkler heads 21 when the pin 14 pushes against the camber 15, typically because of a reduction or loss of water pressure from pipe 22.

The valve 10 may be any commercially available three-way valve, such as those made by Victaulic Co., Reliable Automatic Sprinkler Co., and Globe Fire Sprinkler Corp. However, for such commercially available valves, modification may be required to ensure that the seat 11 does not pull up and allow water to flow from the source 16 into the system 20 when a vacuum is applied. Such modifications may include using a stronger hinge 12 and/or a stronger spring-loaded camber 15 and hinge 13 mechanism.

When the sprinkler system is inactive, the sprinkler piping 20 is substantially dry. The piping 20 is preferably maintained at a vacuum during periods of inactivity. The applied vacuum is preferably below atmospheric pressure at a vacuum pressure between about 2 inches and about 10 inches of mercury. The vacuum may be applied to the piping 20 by a vacuum apparatus 50 that draws air from the piping through a vacuum pipe 40. The vacuum pipe 40 must be airtight to permit the vacuum apparatus 50 to apply the vacuum. Optionally, the vacuum apparatus 50 may be capable of applying higher pressures such as vacuum pressures in the range of about 27 to about 30 inches of mercury. In such an embodiment, a pressure regulator 42 may be provided to step down the applied vacuum to a desired level (i.e., a level within the design pressure capability of the sprinkler drops in the sprinkler system). For example, the vacuum level may be between about 2 inches and about 10 inches of mercury. Other vacuum levels are possible without departing from the scope of the invention. Once the vacuum has been applied, one or more of the sprinkler heads 21 may be removed to allow the siphoning of trapped water from the corresponding sprinkler drops.

The pin 14 may position the camber 15 to keep the seat 11 in place after the vacuum is applied to the piping system 20. The pin 14 may be held in place by water pressure from a pipe 22 that receives water from a source 24. Source 24 may be the same source as the primary water source 16, or it may be a different source. The pin 14 triggers the camber 15 and releases the seat 11 when water pressure from pipe 22 is relieved. Water pressure may be relieved in pipe 22 in one or more ways.

In an embodiment, a first solenoid 28 may relieve the water pressure in pipe 22 by triggering a first valve 26 to open and allow water from source 24 to be directed to a drain 34. The first solenoid 28 may be activated by the detection of heat and/or smoke that would be indicative of a fire that requires activation of the sprinkler system 20. The first solenoid 28 may include heat and/or smoke detection capabilities, or it may be connected to a separate heat and/or smoke sensor (not shown).

In an embodiment, a vacuum loss detection mechanism 32 may relieve the water pressure in pipe 22 by triggering a second valve 30 to open and allow water from source 24 to be directed to the drain 34. The vacuum loss detection mechanism 32 may directly detect an accidental loss of vacuum in the piping system 20, or a vacuum sensor (not shown) located within the piping system 20 may trigger the vacuum loss detection mechanism 32.

In an embodiment, either the heat/smoke sensor or the vacuum loss detection mechanism 32 may direct water from source 24 away from the piping system 20 toward the drain 34. However, in an alternate embodiment, both the heat/smoke sensor and the vacuum loss detection mechanism 32 must be activated in order to direct water from source 24 away from the piping system 20 toward the drain 34 and open the seat 11 in valve 10. In an alternate embodiment, the vacuum loss detection mechanism 32, when activated, may signal the vacuum apparatus 50 to apply a vacuum to the piping system 20.

When the sprinkler system is inactive, the vacuum apparatus 50 may only apply a vacuum to the piping system 20 until the piping system achieves a desired vacuum level. Once the desired vacuum level is achieved, the vacuum apparatus 50 may turn off or switch to a power saving or dormant mode.

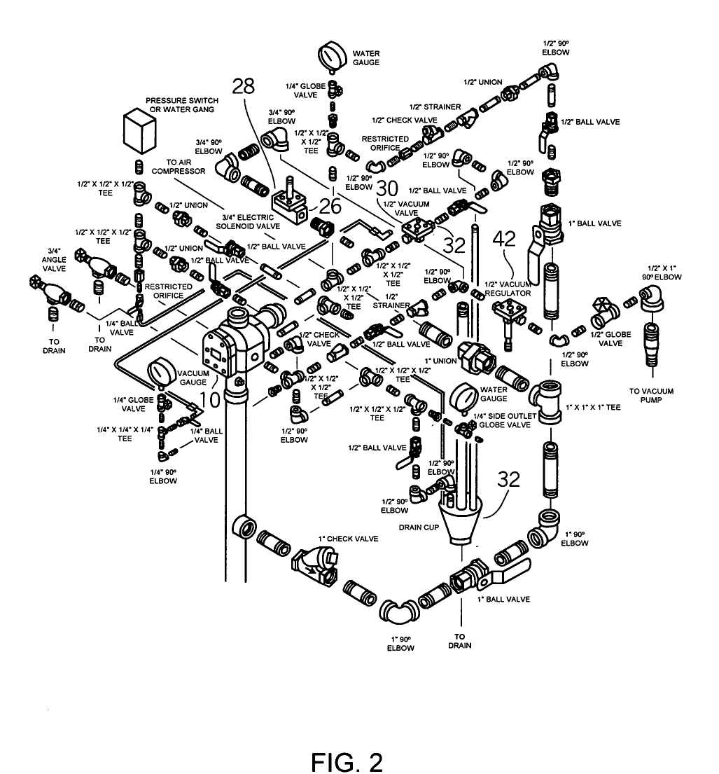

FIG. 2 is an expanded view of several of the features originally illustrated in FIG. 1. For example, the three-way valve 10, the solenoid 28 and valve 26, the vacuum valve 30-32, the drain 34, the vacuum regulator 42 and various pipes are shown. The specific structure, including pipe sizes and configuration, illustrated in FIG. 2 is exemplary only and is not intended to limit this scope of the invention.

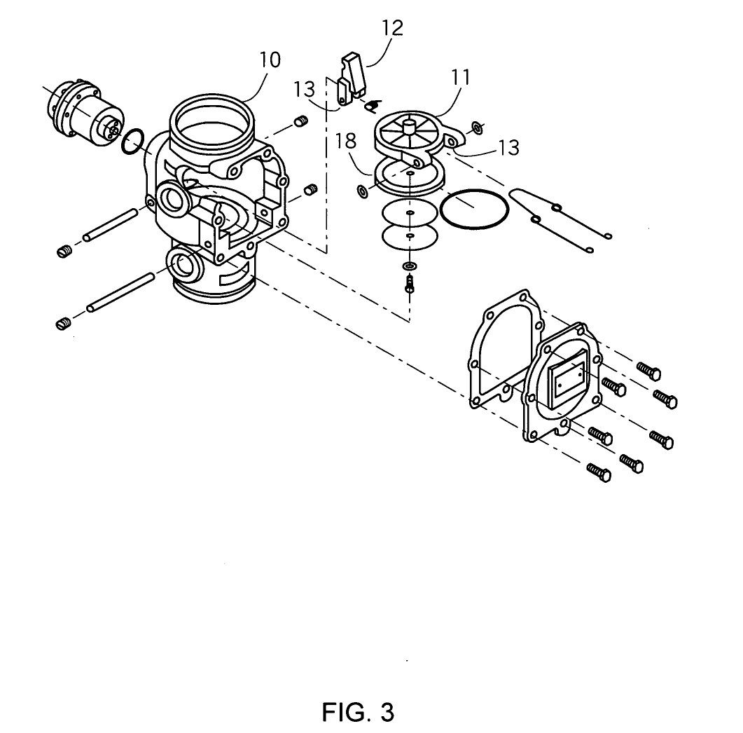

FIG. 3 is an expanded view of an exemplary three-way valve 10 that may be used in accordance with the invention. The valve illustrated in FIG. 3 is one such as may be commercially available and known in the prior art. FIG. 3 illustrates several elements of valve 10, including a seat 11, hinge 13 and spring-loaded camber 15. The seat 11 may include a seal, such as 18, which may be made of, for example, rubber or another water resistant material.

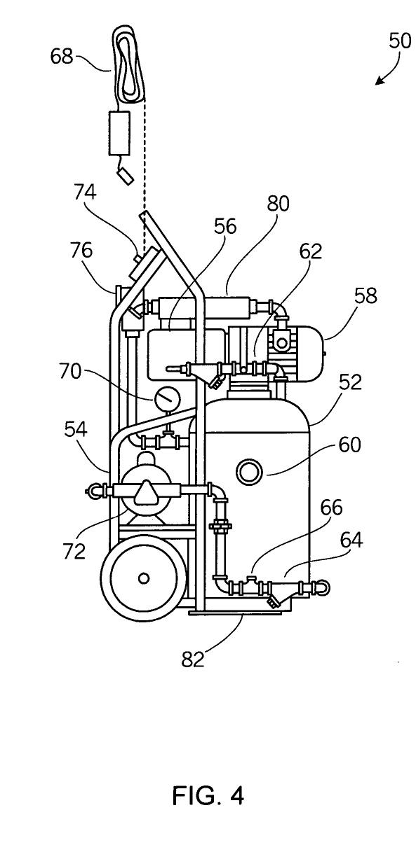

Referring now to FIG. 4, a side view of an embodiment of a vacuum apparatus 50 is shown. The apparatus includes a vessel 52, upon which a frame 54 may be mounted that supports items such as a power source 56 and a vacuum pump 58. The power source 56 may be, for example, a one horsepower electric motor. The power source 56 may be operably connected to and may supply power to the vacuum pump 58. The vessel 52 may have a suction inlet with a ball valve 62 on one end, and a sight glass 60 on the opposite end. Drain valve 64 may extend from the bottom of vessel 52, with an optional check valve 66 and drain pump 72. The vessel 52 may be mounted on one or more supports 66 with optional apertures for conveniently mounting to skids or wheels (not shown). A power cord 68 may extend from the power source 56 and may be coiled on a hook (not shown) located on the apparatus 50. The apparatus 50 may also include one or more of a pressure gauge 70, an on/off switch 74, an air filter 76, a pressure regulator and a muffler 80.

The vessel 52 is preferably an ASME compliant tank. While the vessel 52 may be any size, the vessel 52 preferably has a 10 to 50 gallon capacity, and most preferably is of a size that does not make the apparatus 50 difficult to move and/or transport. However, vessels of other sizes, such as vessels having five-gallon capacities or larger capacities, are possible. The vessel 52 may be made of a material that is impervious to water, such as a metal. Although a tank is depicted as vessel 52 in FIG. 4, it is recognized that other containers may be contemplated within the scope of this invention. In this embodiment, the drain valve 64 is approximately 1.5 inches in diameter and may protrude from the bottom of vessel 52. However, it is recognized that other means for draining the vessel 52 may be contemplated within the scope of this invention.

Vacuum pumps 58 contemplated for use with the invention may include a piston, a fan and one or more screw type pumps (e.g., cylinder bounded devices for moving fluids such as air). In an embodiment, a piston type vacuum pump 58 operating at 1725 revolutions per minute and capable of generating a reduced pressure/pressure differential of approximately 0 to approximately 30 inches of mercury may be used. In such an embodiment, the vacuum pump 58 may create a stable reduced pressure of about 10 inches of mercury. It is also recognized that any vacuum pump capable of generating a stable reduced pressure of about 10 inches of mercury may be used and still fall within the scope of the invention, as most current sprinkler systems use couplings that can withstand a pressure of up to 10 inches of mercury. However, systems may operate at higher or lower vacuum pressures and still fall within the scope of the invention.

The power source 56, illustrated in FIG. 4, may be, for example, an electric motor capable of generating about three horsepower. However, it is also recognized that any power source or engine capable of generating power sufficient to operate the vacuum pump 58 may be used and still fall within the scope of the invention. For example, the stability of the reduced pressure may increase and an increased number of sprinkler heads 21 may be removed at once by using a motor with increased maximum horsepower.

As indicated by FIG. 4, the power source 56 provides power to the vacuum pump 58. In this embodiment, the power source 56 is positioned on the frame 54 above and on the opposite side of the vessel 52 from the vacuum pump 58. A coupling guard may cover a coupling that runs between the power source 56 and the vacuum pump 58. In the embodiment depicted in FIG. 4, the power source 56 has an external power source, e.g. an electric outlet, and power cord 54. Other structures and engine types are possible within the scope of the invention. In addition, other components of the apparatus 50 may be positioned differently, but still fall within the scope of the invention.

In an embodiment, a method of removing water includes providing an apparatus such as that discussed herein, connecting the apparatus to a sprinkler system, and creating a reduced pressure within the system. The connection may occur in several places, such as a gang valve. The main gang drain valve may reside on the inside or outside of the building which houses the sprinkler system, and a multi-story building may have only one gang drain valve for the entire system, or one gang drain valve for each floor of the building. In this embodiment, once a vacuum pressure is established in the apparatus using the vacuum pump 58, water is removed from the sprinkler drops by unscrewing the sprinkler head 21 from each sprinkler drop. Once each sprinkler head 21 is unscrewed, the vacuum pressure established by the vacuum pump 58, which creates a pressure differential between the pressure in the sprinkler system 20 and the atmospheric pressure outside the sprinkler system, creates a siphon or vacuum that removes the trapped water from the sprinkler head drop. The trapped water is siphoned from the sprinkler head drop through the sprinkler system pipes, possibly all the way to the vessel 52. The system may use a filter to prevent water from backing up from the vessel 52 into the vacuum pump 58.

It is recognized that the apparatus may be attached to any point on the sprinkler system where a hose can be connected such that an airtight seal may be created between the hose and the sprinkler system 20. The sprinkler system 20 may be breached at any point on a sprinkler head drop such that the inside of the pipe drop is exposed to air at the atmospheric pressure, causing the siphon that transports the trapped water in the sprinkler drop to the vessel 52 on the apparatus 50. An alternate embodiment of the vacuum apparatus is illustrated in co-pending U.S. patent application Ser. No. 10/040,094, of which FIGS. 1-4 and the accompanying text are incorporated herein by reference. Alternate vacuum devices may also be used. However, the apparatus described above and the apparatus illustrated in U.S. patent application Ser. No. 10/040,094 may be used in preferred embodiments since such an apparatus may provide additional benefits as described in U.S. patent application Ser. No. 10/040,094.

The present system may provide several advantages. For example, water delivery to remote areas of a piping system may occur more quickly than in normal dry systems, since the relief of a vacuum system effectively sucks water from the water source through the piping. In other words, water is quickly pulled through the pipe, rather than pushed through the pipe from a water source. This effect also provides benefits for residential systems and other sprinkler systems that use plastic pipes, which may not be able to endure, or which may react with loud sounds to, the pressure caused when water is pushed through the pipes. Further, unlike existing vacuum systems, the vacuum pipe in the present inventive system need only operate until the vacuum level is achieved in the piping system. Once the vacuum level is achieved, the vacuum apparatus may shut off or may switch to a dormant mode until the vacuum pressure is relieved, either by an air leak or by activating the sprinkler system because of heat for a fire.

It is to be understood that the invention is not limited in its application to the details of construction and to the arrangements of the components set forth in this description or illustrated in the drawings. The invention is capable of other embodiments and of being practiced and carried out in various ways. Hence, it is to be understood that the phraseology and terminology employed herein are for the purpose of description and should not be regarded as limiting.

As such, those skilled in the art will appreciate that the conception upon which this disclosure is based may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

1. A dry sprinkler system, comprising:
a network of pipes and sprinkler drops;
a first water source;
a first valve that, when activated, causes water to be delivered to the network from the first water source; and
a vacuum apparatus that, when activated, maintains a regulated vacuum on the network.

2. The system of claim 1 wherein the regulated vacuum is a pressure between about 2 inches and about 10 inches of mercury.

3. The system of claim 1 wherein the first valve is a three-way valve having a first port connected to the first water source, a second port connected to a second water source, and a third port connected to the network, and wherein the first valve is activated by water from the second water source being removed from the second port.

4. The system of claim 1, further comprising a sensor that activates the first valve when a fire event is detected.

5. The system of claim 4 wherein the sensor is a pressure sensor.

6. The system of claim 4 wherein the sensor is a heat sensing solenoid.

7. The system of claim 4 wherein the sensor is a smoke sensing solenoid.

8. The system of claim 1, further comprising a pressure regulator for monitoring the regulated vacuum.

9. The system of claim 8 wherein the vacuum apparatus is activated when the pressure regulator detects a pressure above a predetermined level.

10. The system of claim 8 wherein the vacuum apparatus is deactivated when the pressure regulator detects a pressure below a predetermined level.

11. A dry sprinkler vacuum application system, comprising:
a valve having at least three ports, including a first water source port, a second port, and a water delivery port, wherein the valve includes a seat that, when closed, prevents water from being delivered from the first water source port to the water delivery port;
an actuator that, when activated, causes the seat to open so that water is delivered from the first water source port to the water delivery port; and
a vacuum apparatus that, when activated, creates a vacuum on a sprinkler piping network attached to the water delivery port.

12. The system of claim 11, further comprising a pressure regulator, wherein the vacuum apparatus is activated when the pressure regulator detects a pressure above a first predetermined level.

13. The system of claim 12 wherein the vacuum apparatus is deactivated when the pressure regulator detects a pressure below a second predetermined level.

14. The system of claim 11 wherein the actuator comprises a water source and a sensor, wherein the actuator is activated by directing the water source away from the second port upon detection of a fire event by the sensor.

15. A method of creating a vacuum in a dry sprinkler system, comprising:
connecting a vacuum apparatus to a sprinkler system, wherein the sprinkler system includes one or more sprinkler drops;
establishing, by the vacuum apparatus, a vacuum in the sprinkler system, wherein the vacuum is within a design pressure capability of the one or more sprinkler drops;
monitoring, by a pressure regulator, the vacuum; and
automatically re-establishing, by the vacuum apparatus, the vacuum when the pressure regulator detects a pressure change in the sprinkler system.

16. The method of claim 15, further comprising, after the vacuum is established, removing one or more sprinkler heads from their corresponding sprinkler drops in the sprinkler system to siphon trapped water from the sprinkler drops.

17. The method of claim 15, further comprising removing the vacuum when a fire event is detected.

18. The method of claim 15, wherein the vacuum is within a design pressure capability of the sprinkler system.
